(19) United States
(12) Patent Application Publication
(10) Pub. No.: US 2019/0384835 A1
(43) Pub. Date: Dec. 19, 2019

(54) INGESTION ENGINE METHOD AND SYSTEM

(71) Applicant: SAP SE, Walldorf (DE)

(72) Inventors: Lu Luo, San Francisco, CA (US); Yi Song, Shanghai (CN)

(21) Appl. No.: 16/008,441

(22) Filed: Jun. 14, 2018

(51) Int. Cl. G06F 17/30

(52) U.S. Cl. CPC G06F 17/30227; G06F 17/30144; G06F 17/30569; G06F 17/30448

(57) ABSTRACT

A method and system including writing a stream of data messages to a first data structure of a first data storage format, the data messages each being written to the first data structure based on a topic and partition associated with each respective data message; committing the writing of the data messages to the first data structure as a transaction; moving the data messages in the first data structure to a staging area for a data structure of a second data storage format, the data structure of the second data storage format being different than the data structure of the first data storage format; transforming the data messages to the second data storage format; and archiving the data messages in the first data structure after a completion of the transformation of the data messages.

### BACKGROUND

The present disclosure herein generally relates to processing large data sets and, more particularly, to systems and methods for a data ingestion process to move data including streaming data events from a variety of data sources and different table schemas to a data warehouse in a file format that can be stored and analyzed in an efficient and traceable manner.

Some “big data” use-cases and environments may use tables having different schemas, which may present some problems when trying to process data, particularly the processing of streaming data. Additional complexities may be encountered if there is a file count limit for the big data store solution. For example, a count limit may be reached by the processing of too many files, even if the files are each small in size. Furthermore, data volumes to be processed may not be of a stable size. Another concern may be the searchability of the data. Data stored in the data store should preferably be configured, without further undue processing, for being searched based on criteria in a logical manner. Given these and other aspects of a distributed system, multiple different types of errors might typically be encountered during the performance of processing jobs. As such, error handling may be complicated by one or more of the foregoing areas of concern.

Accordingly, there exists a need for a distributed processing system and method solution that, in some aspects, can efficiently handle streaming data events having a variety of different data structure schemas, exhibit a minimal need for data recovery mechanisms, is optimized for query and purge operations, and reduces a level of compaction used to efficiently store data in the data store.

### BRIEF DESCRIPTION OF THE DRAWINGS

FIG. 1 is an illustrative depiction of streaming data records;

FIG. 2 is an illustrative depiction of a log of streaming data records in a partition;

FIG. 3 is an illustrative depiction of a process flow, according to some embodiments;

FIG. 4 is an illustrative flow diagram of a process, according to some embodiments;

FIG. 5 is an illustrative flow diagram of a process including a streaming data writer, according to some embodiments;

FIG. 6 is an illustrative depiction of a streaming data writer process, according to some embodiments;

FIG. 7 is an illustrative depiction of a data file writer process, according to some embodiments;

FIG. 8 is an illustrative depiction of a transformation process, according to some embodiments;

FIG. 9 is an illustrative depiction of a transformation process including error handling aspects, according to some embodiments;

FIG. 10 is an illustrative depiction of a scheduler structure, according to some embodiments; and

FIG. 11 is a block diagram of an apparatus, according to some embodiments.

### DETAILED DESCRIPTION

The following description is provided to enable any person in the art to make and use the described embodiments. Various modifications, however, will remain readily apparent to those in the art.

In some aspects of the present disclosure, a distributed file system may be used to store “big data”. In one embodiment, an Apache Hadoop® cluster comprising Apache HDFS® and Apache Hive® ACID tables may be used to store streaming data to leverage storage and query effectiveness and scalability characteristics of the Hadoop cluster. The streaming data however may not be formatted for efficient storage and/or querying. Instead, the streaming data might be formatted and configured for efficient and reliable streaming performance. Accordingly, some embodiments herein include aspects and features, including an ingestion process, to efficiently and reliably transform the streaming data into data structures (e.g., data tables) that can be stored and further analyzed.

Prior to discussing the features of the ingestion process(es) herein, a number of aspects will be introduced. In some instances, the streaming data that may be received and processed by methods and systems herein may be Apache Kafka® data events, messages, or records. Kafka is run as a cluster on one or more servers that can serve a plurality of datacenters. A Kafka cluster stores streams of records produced by publishers for consumption by consumer applications. A Kafka publisher publishes a stream of records or messages to one or more Kafka topics and a Kafka consumer subscribes to one or more Kafka topics. A Kafka data stream is organized in a category or feed name, called a topic, to which the messages are stored and published. Kafka topics are divided into a number of partitions that contain messages in an ordered, unchangeable sequence. Each topic may have multiple partitions. Multiple consumers may be needed or desired to read from the same topic to, for example, keep pace with the publishing rate of producers of the topic. Consumers may be organized into consumer groups, where topics are consumed in the consumer groups and each topic can only be consumed in a specific consumer group. However, one consumer in a specific consumer group might consume multiple partitions of the same topic. That is, each consumer in a consumer group might receive messages from a different subset of the partitions in a particular topic. FIG. 1 is an illustrative depiction of some aspects of a Kafka data stream including a topic T1 at 105 that is divided into four partitions (Partition 0, Partition 1, Partition 2, and Partition 3). As shown in the example of FIG. 1, a consumer group 110 includes two consumers (i.e., Consumer 1, Consumer 2), where topic T1 is consumed by consumer group 110 and the consumers 115, 120 in consumer group 110 each subscribes to and consumes multiple partitions of topic T1 (105).

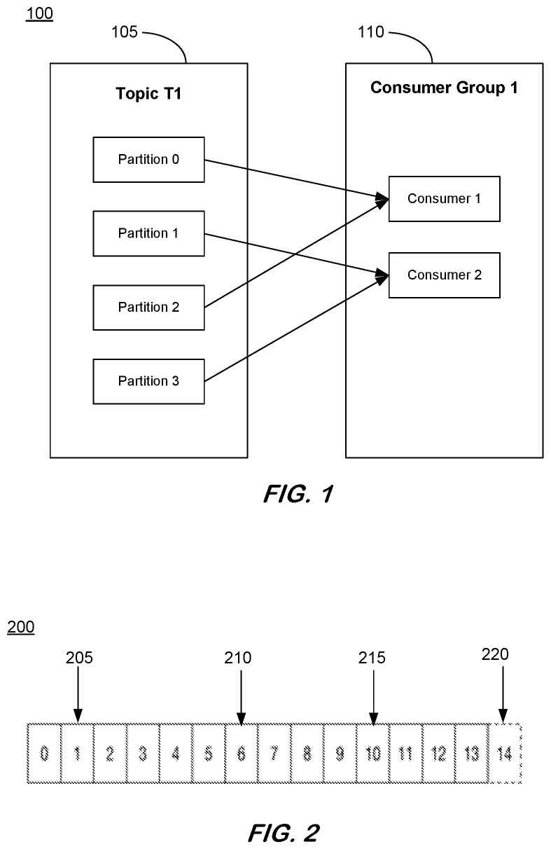

For each topic, a Kafka cluster maintains a partitioned log 200 as illustratively depicted in FIG. 2, where records (also referred to herein interchangeably as messages) in a partition are each assigned a sequential identifier (id), called an offset, when published that uniquely identifies each record within the partition. When a Kafka consumer consumes a Kafka message, the message is consumed in ascending order of offset to a specific partition (i.e., from small to big), not topic. There may be different types of offsets for a partition. A current position offset 205 is generated when a consumer consumes a Kafka message and the offset is increased by 1. A last committed offset 210 is the last acknowledged offset and can be characterized by two modes, automatic and manual. In the automatic mode, the offset will be automatically committed when a message is consumed. In the manual mode, the offset can be acknowledged by an API. A high watermark type offset refers to the offset where all messages below are replicated and is the highest offset a Kafka consumer can consume. FIG. 2 further includes a log end offset 220 that is at the end of the partition 200.

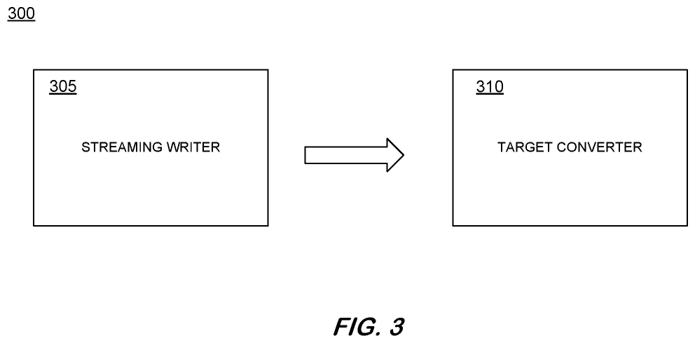

FIG. 3 is an illustrative depiction of one example process 300 herein. Process 300 is one embodiment of an ingestion process and includes, at a high level, two steps or operations 305 and 310. An example associated with FIG. 3 in one embodiment includes a data stream comprising a Kafka data stream and a target data storage including a Hadoop cluster (e.g., HDFS+Hive ACID tables). Operation 305 includes a streaming writer. In the example of FIG. 3, the streaming writer 305 writes Kafka events (i.e., messages) to ingestion HDFS folders or other data structures organized by the topic and partition of the Kafka messages. Additionally, the writing of the Kafka messages is processed as a transaction, wherein the Kafka offset associated with the writing operation is acknowledged when the HDFS write is completed or finished. By acknowledging the Kafka offset only after the HDFS write is finished, process 300 can avoid having to include a data recovery mechanism or the streaming writer since either the write operation occurs (and is acknowledged) or it does not happen (i.e., no acknowledgement). In some embodiments, operation 305 may include merging the Kafka events, which are typically small files, and writing the merged files to a write-ahead log (WAL). In the example of FIG. 3, one WAL is used for each Kafka partition to allow acknowledgement. In some aspects, merging the Kafka files limits a total number of files and may thus avoid overburdening a Namenode. In some instances, the merging of the Kafka files may have the benefit of increasing throughput (e.g., about 10×).

Operation 310 may include a target file converter to transform the Kafka events to the desired, target format that is optimized for querying, analysis, and reporting. Operation 310 may include moving the files from staging folders of streaming writer 305 to staging folders data of the target format. In one embodiment, the files are moved from the HDFS staging folders to Hive staging folders or data structures. An Extraction, Transform, Load (ETL) process is further performed to transform the Kafka data into target ACID tables. In some instances, the Kafka data may be imported into the ACID tables using a Hive query operation. Upon completion of importing the Kafka data into the target formatted data structures (e.g., Hive ACID tables), the processed filed can be achieved. In agreement with a configurable setting, the archived files may be purged after a period of time. Referring to FIG. 3 overall, the processes therein may be implemented such that no data or status is stored in local disks and is instead all stored in-memory.

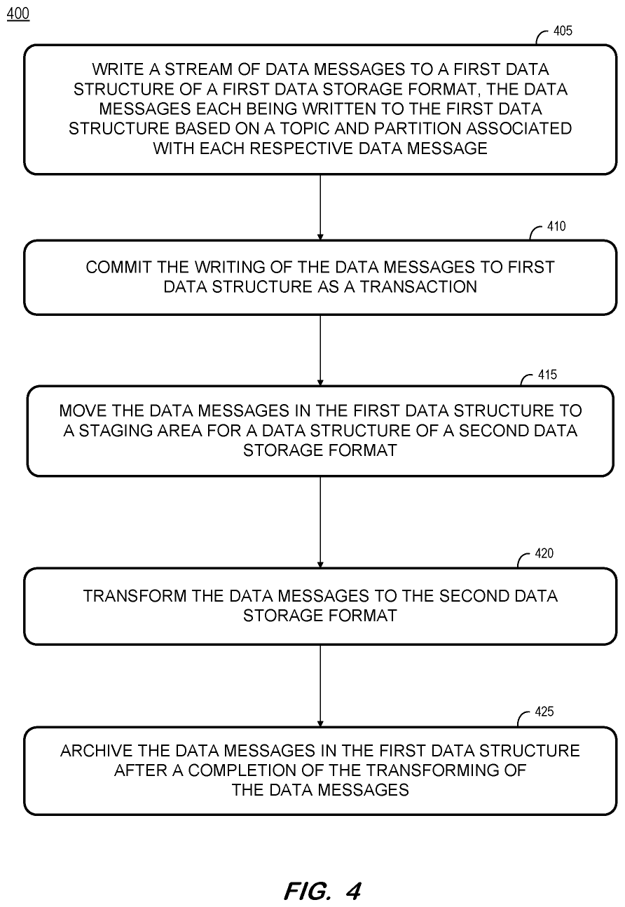

FIG. 4 is a flow diagram of a process herein, in accordance with some embodiments. At operation 405, a stream of data messages (e.g., Kafka data messages, events, or records) is written to a first data structure of a first data storage format. In one embodiment, the first data structure of the first data storage format is a HDFS table. The data messages are written to the first data structure of the first data storage format based on the topic and partition identifiers associated with each of the data messages.

At operation 410, the writing of the data messages is committed to the first data structure, in a transactional manner. The transactional nature of the writing and commitment thereof may obviate a need for a data recovery mechanism regarding operation 405. In this manner, additional resources and/or complexity need not be devoted to a data recovery process.

Proceeding to operation 415, the data messages in the first data structure may be moved to a staging area for a second data structure of a second data storage format (e.g., Hive ACID). As seen by the present example, the first data structure of the first data storage format (e.g., HDFS) is not the same as the second data structure of the second data storage format (e.g., Hive ACID).

At operation 420, the data messages are transformed to the second data structure of the second data storage format. In this example, the Kafka messages are transformed to into Hive ACID tables. Hive ACID tables are configured and optimized for efficient storage and querying of the data therein. As such, the Kafka messages may be queried and otherwise searched and manipulated in a fast and efficient manner when stored in Hive ACID tables as a result of the transformation operation 420.

At operation 425, the data messages may be archived after the transformation of operation 420. In some aspects, the archived records may be purged or otherwise discarded after a defined period of time. The defined period of time might correspond to a service level agreement (SLA) or some other determining factor.

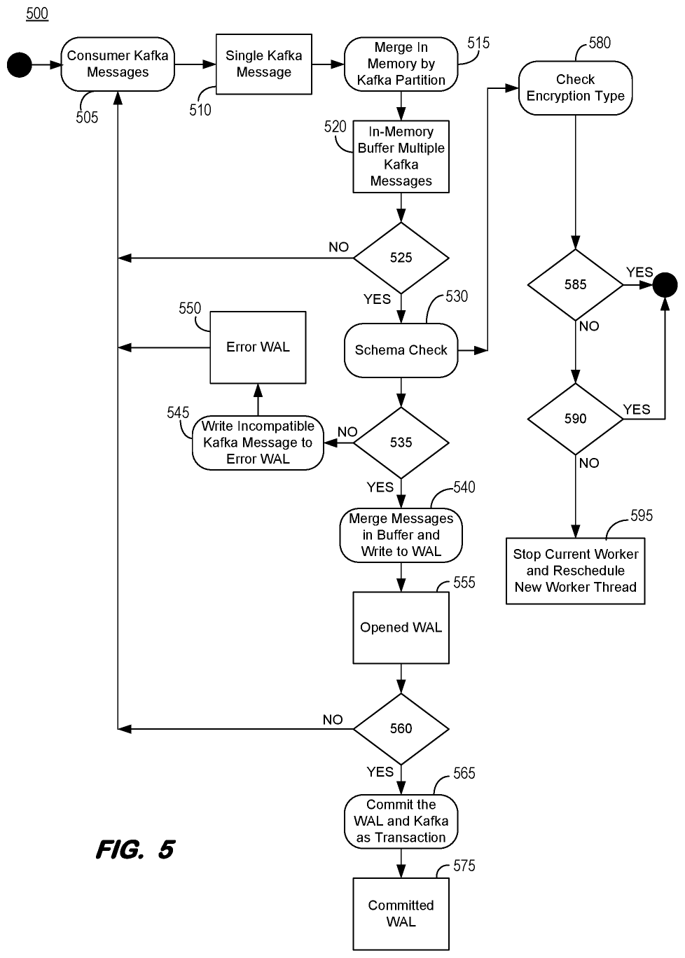

FIG. 5 is an illustrative depiction of a process 500, in accordance with some embodiments herein. Process 500, in some aspects, relates to a streaming writer process and provides additional details for some aspects of the processes of FIGS. 3 and 4. At operation 505, streaming data comprising Kafka messages are received by a Kafka consumer. The streaming data includes a sequential flow of single messages 510. Processing and storing each of the messages in HDFS may entail too many files for a system's storage capabilities. At 515, the single Kafka messages are merged in-memory by Kafka partition and stored in an in-memory buffer 520, where messages belonging to a given partition are merged together in a same file.

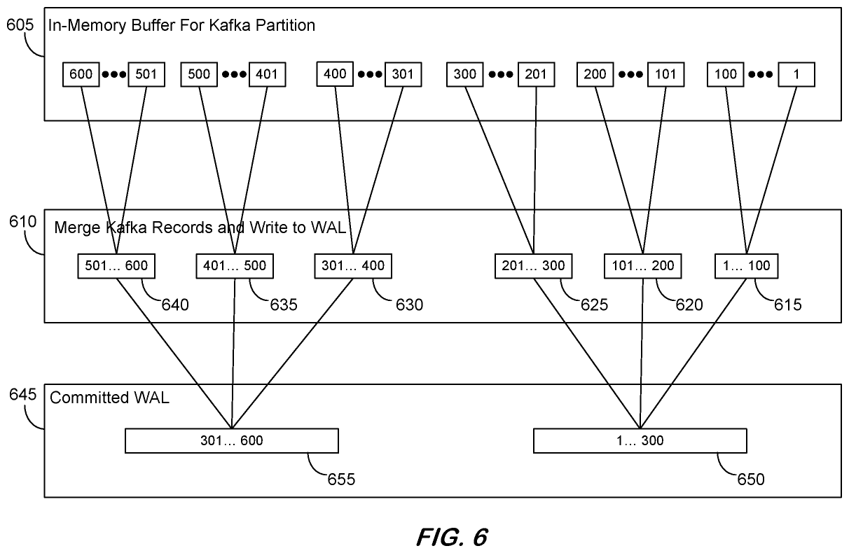

FIG. 6 is an illustrative depiction of a process, according to some embodiments. FIG. 6 illustrates at 605 an in-memory buffer for a Kafka partition. In particular, buffer 605 is an in-memory queue 605 of Kakfa records for a Kafka partition, ordered by offset. As shown, buffer 605 includes a plurality of records (i.e., messages) ordered by offsets from, for example, 1 to 600, where the last offset “600” is not fixed but is determined by the number of messages. In the example of FIG. 6, buffer 605 may include Kafka records pertaining to, for example, Topic A-Partition 1.

At operation 525, a determination is made whether a predefined threshold size for the buffer 520 is satisfied. If not, then process 500 returns to 505 and a next Kafka message 510 is consumed. When the predefined threshold size for the in-memory buffer 520 is satisfied by the merged multiple Kaka messages, the process proceeds from operation 525 to operation 530 where a schema of the Kafka messages is checked for compatibility with the processing system implementing process 500. In some instances and use-cases, the schema compatibility check at operation 530 may reduce or eliminate a need for schema-related compatibility issues at later processing operations. If a schema compatibility issue is determined at 530, then the type of error is determined at 580 to determine how to handle the exception. If the exception or error is fatal, as determined at operation 585, then the worker thread executing process 500 stops. If the exception is not fatal but a retry threshold limit has been satisfied as determined at operation 590, then the process also ends. If the exception is not fatal but a retry threshold limit has not been satisfied at 590, then the process proceeds to operation 595 where the current worker thread may be stopped and a process 500 may be rescheduled with a new worker thread.

In the event there is a schema compatibility issue at 535 that is not fatal, then an incompatible Kafka message error 545 may be recorded in a log such as, for example, a write-ahead log (WAL) 550 and the process will continue to 505 to process new Kafka messages. In the event the Kafka messages are determined to be compatible at operation 535, then the messages in the buffer can be merged and written to a log (e.g., a WAL) at 540.

FIG. 6 includes an illustrative depiction of the Kafka records in a buffer 605 being merged at 610, where the merged Kafka records are further written to a WAL. As shown, records with offsets 1-100 are merged create record 615, records with offsets 101-200 are merged to create record 620, records with offsets 201-300 are merged to create record 625, records with offsets 301-400 are merged to create record 630, records with offsets 401-500 are merged to create record 635, and records with offsets 501-600 are merged to create record 640. The merged Kafka records are flushed in the queue and written to HDFS, as shown at operation 540 in FIG. 5.

Returning to FIG. 5, additional Kafka messages may be added to the WAL opened at 555 until a threshold size for the WAL is reached. If the WAL including the merged Kafka messages has not yet reached the threshold size as determined at 560, then the process will return to 505 to process new Kafka messages. If the WAL including the merged Kafka messages has reached the threshold size, then the process will continue to operation 565 to commit the WAL and Kafka messages as a transaction.

Referring to FIG. 6, a committed WAL is shown at 640 where the “micro-batches” of merged Kafka records written to HDFS are committed by a process that includes acknowledging the latest offset of each micro-batch after it is written to HDFS. For example, a commitment of Kafka messages 301-600 occurs when file 655 including these messages is successfully written to the HDFS and the file is marked as committed. A similar process is performed for committing Kafka messages 1-300 (i.e., file 650).

Prior to committing the WAL and Kafka messages as a transaction at 565, the WAL is checked for errors at 580 to determine an exception type, if any. If the exception or error is fatal, as determined at operation 585, then the worker thread executing process 500 stops. If the exception is not fatal but a retry threshold limit has been satisfied as determined at operation 590, then the process ends. If the exception is not fatal but a retry threshold limit has not been satisfied at 590, then the process proceeds to operation 595 where the current worker thread may be stopped and a process 500 may be rescheduled with a new worker thread. The WAL is committed at operation 575 and the process will return to 505 to process new Kafka messages.

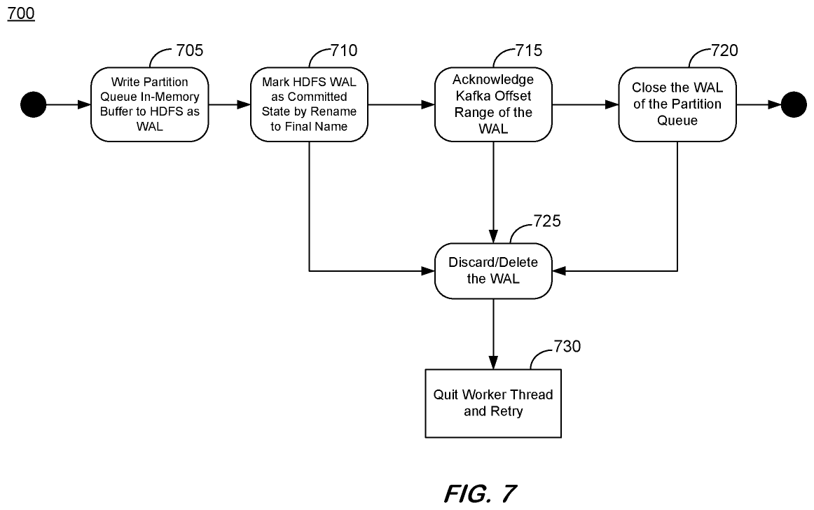

FIG. 7 is an illustrative depiction of a streaming writer process, including transactional aspects thereof in some embodiments. Process 700 includes four steps. Operation 705 includes writing a partition queue in-memory buffer to a HDFS log (e.g., WAL). The writing of the partition queue to the log is monitored for an exception or error. If an exception is determined, then the particular log may be deleted or otherwise discarded at operation 725.

At a second step 710, the state of the HDFS log may be marked as committed by, for example, renaming it to a final name to make it consumable by a next step. For example, a file “TopicA_partition1.avro.staging” may be renamed to “TopicA_partition1-o100-200.avro”, where the “100-200” refers to the offset of the Avro file being from 100-200. In this example, the files are formatted as an Avro record that includes data structure definitions with the data, which might facilitate applications processing the data, even as the data and/or the applications evolve over time. The renaming of the WAL HDFS filename may be monitored for an exception or error. In this second step, the HDFS WAL is marked as a final state to ensure the record is written exactly once to HDFS (i.e., no duplicate records) for the next step in the conversion process of FIG. 7. If an exception is determined here, then the particular log may be deleted or otherwise discarded at operation 725.

Continuing to step three of process 700, the Kafka offset range of the log record committed at operation 710 is acknowledged. For example, an acknowledgement of offset 200 of TopicAPartitionl is acknowledged as already written to WAL. If there is a failure to acknowledge the Kafka offset, then the particular log may be deleted or otherwise discarded at operation 725. In the event there is an exception in either of steps 705, 710, and 715, there may be no need for an additional rollback of the streaming Kafka data, instead the worker thread executing process 700 may quit and be restarted, as shown at 730. Continuing to step 4, the log (e.g., WAL) of the partition is closed after the acknowledgement of step 3, operation 715.

In accordance with process 700, some embodiments herein may operate to implement a Kafka-HDFS streaming writer as a transactional process, using exact-one semantics. In some embodiments, process 700 is not limited to Kafka messages/events. In some embodiments, process 700 may be implemented to systems with a queue that employs ever-increasing commit offsets. Aspects of process 700 support load balancing and scalability in some embodiments. For example, load balancing may be achieved by Kafka consumer groups by adding more HDFS writer processes to handle an additional load. Alternatively or additionally, the number of worker thread pools may be increased. For scalability, the HDFS writer of process 700 may support horizontal scaling without a need for recovery, where an upgrade might be achieved by killing the node and upgrading.

Referring to, for example, process 500 and 700, error handling is incorporated into some embodiments herein. In general, exceptions or errors may be classified into three categories, including fatal errors, non-fatal errors, and incompatible schema detected errors. Fatal errors cannot generally be recovered from and the executing process should immediately cease. Examples of a fatal error may include, for example, an out of memory (00M) error, a failed to write to WAL error, and a failed to output log error. A non-fatal error may generally be recoverable from and may be addressed by quitting the current worker thread and retrying the process (e.g., after a predetermined or configurable period of time). However, if a maximum number of retries has been attempted (i.e., a retry threshold), then the process may be stopped. A non-fatal error might include, for example, a failed to write to HDFS error, a HDFS replication error, and a Kafka consumer timeout error. For an incompatible schema detected error, the Kafka message cannot be discarded and the messages will need to be written to an error log (e.g., WAL), as soon as possible.

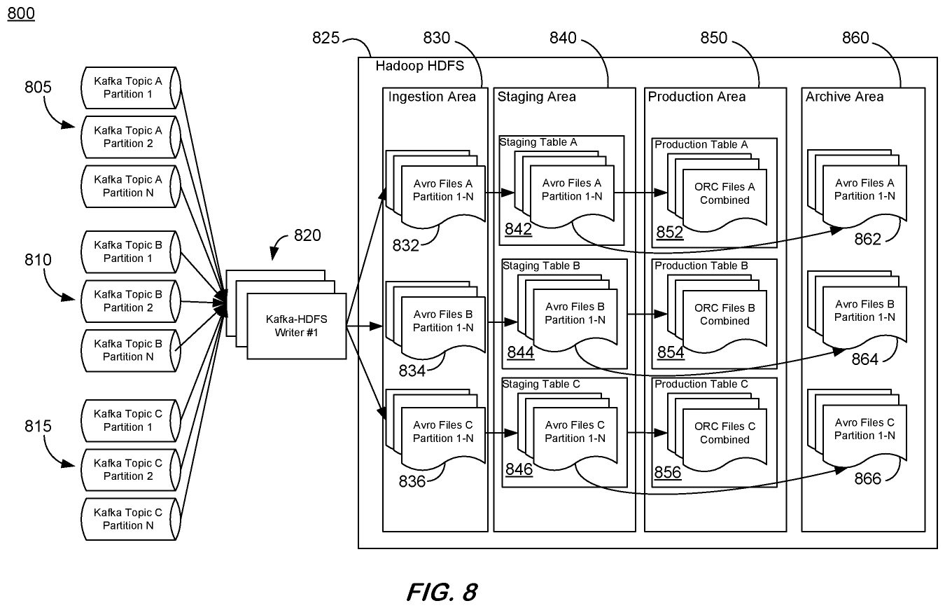

FIG. 8 provides an illustrative overview of some aspects of a target file converter process 800 herein, in some embodiments. For an example of FIG. 8, the target file format will be Hive ACID tables and FIG. 8 will be discussed in the context of a ACID converter, although other file formats are contemplated, applicable, and compatible with the present disclosure. FIG. 8 shows Kafka messages organized by topic and partition, including TopicA 805 (including TopicA, partitions 1, 2, . . . N), TopicB 810 (including TopicB, partitions 1, 2, . . . N), and TopicC 815 (including TopicC, partitions 1, 2, . . . N). The Kafka messages are process by a Kafka-HDFS writers 820 and stored in ingestion area 830 as Avro formatted files, in accordance with other disclosures herein (e.g., FIGS. 5 and 7). In the example of FIG. 8, the demonstrated process is implemented in Hadoop HDFS and the Avro files are organized by topic and partition, including files 832 (e.g., TopicA and its Partitions 1-N), 834 (e.g., TopicB and its Partitions 1-N), and 834 (e.g., TopicC and its Partitions 1-N).

In a first step of the ACID-converter process, the Avro data files are moved to a staging area 840 as a staging table. A staging table 842, 844, and 846 is established for each of the records 832, 834, and 836, respectively, from ingestion area 830. The staging tables (i.e., data structures) are formatted as Avro files in the example of FIG. 8. In some embodiments, a HDFS file system API may be used to implement the move.

In a second step of FIG. 8, the data in the Avro formatted tables is converted to a target (i.e., second) format. In the example of FIG. 8, Avro formatted files are converted or transformed into the Optimized Row Columnar (ORC) file structure corresponding to the storage format for Apache Hive® and stored in a production area 850 as production tables. A production table 852, 854, and 856 is established for each of the records 842, 844, and 846, respectively, from staging area 840. In some embodiments, a HiveQL (i.e., query language) query script may be used to implement the transformation of step 2 in FIG. 8.

In a third step of FIG. 8, the Avro formatted data in staging area 840 may be moved to an archive area 860 to clear the ingestion area. The archived Kafka message files may be deleted or otherwise discarded after some configurable period of time (e.g., 30 days). In some aspects, the external staging Hive tables and the internal ACID productions tables may need to be created, as a prerequisite to the execution of the data conversion process of FIG. 8 and some other embodiments herein.

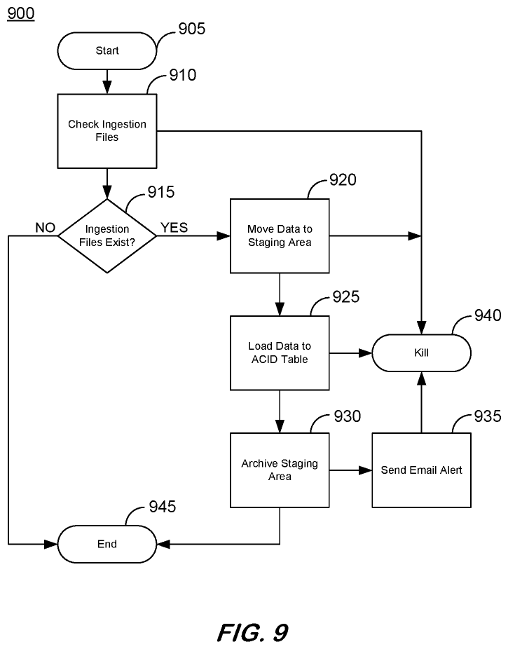

In some aspects, FIG. 9 relates to a detailed view and aspects of a target file converter process 900 herein, including exception or error handling. Process 900 is initiated at 905 and at operation 910 the files at an ingestion area are checked for errors. In the event there is an error in the ingestion files, then the target file conversion process may be ended at operation 940. Otherwise, the target file conversion process may continue to operation 915. At operation 915, a determination is performed to determine whether data structure(s) exist to accommodate the ingestion files (e.g., external staging tables and ACID production tables). If not, then process 900 may be stopped at 945. If the requite file structures exist, then the data files may be moved from the ingestion area to the staging area at operation 920. The moving operation is further checked for error(s) and if an error exist, then process 900 may be stopped at 940. If no error(s) are encountered with moving operation 920, process 900 may proceed to operation 925 where the data is transformed to the target data format and loaded to the ACID tables. Here also, the transformation operation 925 is checked for error(s) and if an error exist, then process 900 may be stopped at 940. If no error(s) are encountered with transforming operation 925, process 900 may proceed to operation 930 where the files now loaded to the ACID tables are moved and archived in the archive area. The archiving operation 930 is also checked for error(s) and stopped at 940 if there are error(s). If no error(s) are encountered with archiving operation 930, process 900 may proceed to completion and end at 945.

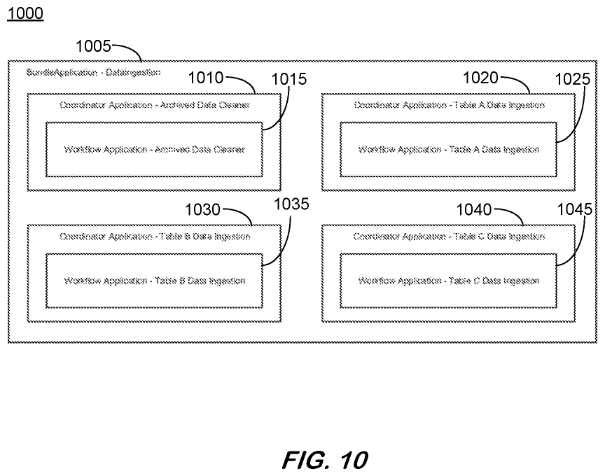

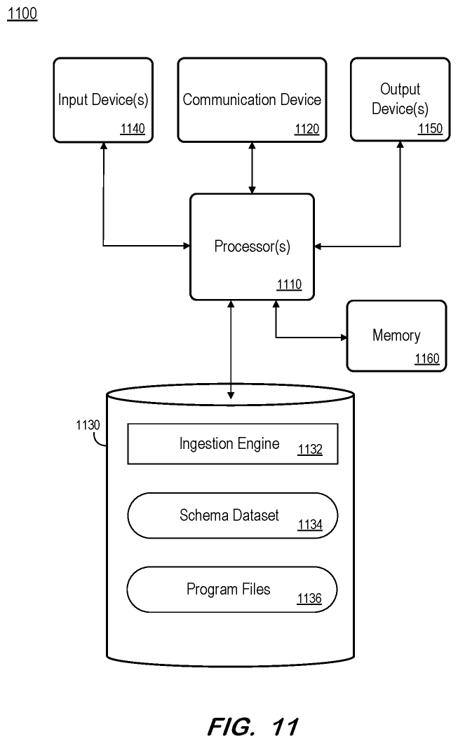

In some aspects, various applications and process jobs herein may be controlled and implemented by a workflow scheduler. In one embodiment herein, the workflow scheduler may be Apache Oozie® scheduler for Hadoop. However, the present disclosure is not limited to the Oozie scheduler and other schedulers may be used, depending for example on a platform and/or application. For example, a cleaner application may be periodically executed against the archive layer to free HDFS space and other jobs may be executed to implement a batch ingestion workflow. In some aspects, FIG. 10 is an illustrative depiction of an Oozie application structure 1000 for performing a number of different jobs in some embodiments herein. As shown, a bundle application 1005 is used to contain and control a number of coordinator applications (e.g., 1010, 1020, 1030, and 1040) that each defines and executes recurrent and interdependent workflow jobs (e.g., 1015, 1025, 1035, and 1045). FIG. 10 is an example of a scheduler structure for one embodiment herein and might include more, fewer, and other coordinators and workflows than those depicted in FIG. 10 for illustrative purposes.

In some aspects, metrics associated with some of the processes herein may be tracked and monitored for compliance with one or more predetermined or configurable standards. The standard may be defined in a SLA for an implementation of the processes disclosed herein. In some embodiments, a start time, an end time, and a duration associated with the jobs executed in performing processes disclosed herein may be monitored and compared to a predetermined nominal time for each. In some embodiments, a scheduler may track any of the times not met and further report, via an email or other reporting mechanism, a notification of a job end time that is not met. Other error handling and reporting strategies may be used in some other embodiments.

FIG. 11 is a block diagram of computing system 1100 according to some embodiments. System 1100 may comprise a general-purpose or special-purpose computing apparatus and may execute program code to perform any of the methods, operations, and functions described herein. System 1100 may comprise an implementation of one or more processes 300, 400, 700, 800, and 900. System 1100 may include other elements that are not shown, according to some embodiments.

System 1100 includes processor(s) 1110 operatively coupled to communication device 1120, data storage device 1130, one or more input devices 1140, one or more output devices 1150, and memory 1160. Communication device 1120 may facilitate communication with external devices, such as a data server and other data sources. Input device(s) 1140 may comprise, for example, a keyboard, a keypad, a mouse or other pointing device, a microphone, knob or a switch, an infra-red (IR) port, a docking station, and/or a touch screen. Input device(s) 1140 may be used, for example, to enter information into system 1100. Output device(s) 1150 may comprise, for example, a display (e.g., a display screen) a speaker, and/or a printer.

Data storage device 1130 may comprise any appropriate persistent storage device, including combinations of magnetic storage devices (e.g., magnetic tape, hard disk drives and flash memory), optical storage devices, Read Only Memory (ROM) devices, etc., while memory 1160 may comprise Random Access Memory (RAM), Storage Class Memory (SCM) or any other fast-access memory.

Ingestion engine 1132 may comprise program code executed by processor(s) 1110 (and within the execution engine) to cause system 1100 to perform any one or more of the processes described herein. Embodiments are not limited to execution by a single apparatus. Schema dataset 1134 may comprise schema definition files and representations thereof including database tables and other data structures, according to some embodiments. Data storage device 1130 may also store data and other program code 1138 for providing additional functionality and/or which are necessary for operation of system 1100, such as device drivers, operating system files, etc.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a processor; and
a memory in communication with the processor, the memory storing program instructions, the processor operative with the program instructions to perform the operations of:
writing a stream of data messages to a first data structure of a first data storage format, the data messages each being written to the first data structure based on a topic and partition associated with each respective data message;
committing the writing of the data messages to first data structure as a transaction;
moving the data messages in the first data structure to a staging area for a data structure of a second data storage format, the data structure of the second data storage format being different than the data structure of the first data storage format;
transforming the data messages to the second data storage format; and
archiving the data messages in the first data structure after a completion of the transformation of the data messages.

2. A system according to claim 1, wherein the committing of the writing of the data messages to first data structure as a transaction includes acknowledging the commitment after the writing data messages to the first data structure is completed.

3. A system according to claim 1, wherein the writing and committing the writing of the data messages to first data structure as a transaction comprises:
writing a partition queue in-memory buffer to the first data storage format as a write-ahead log;
marking the write-ahead log as being in a committed state;
acknowledging an offset range of the write-ahead log; and
closing the write-ahead log of the partition queue.

4. A system according to claim 1, further comprising:
merging a plurality of the data messages until a size of a record of the merged data messages is a threshold size, wherein the committing of the writing of the data messages to first data structure includes writing the record of the merged data messages to the first data structure.

5. A system according to claim 1, wherein the second data storage format is optimized for querying.

6. A system according to claim 1, further comprising creating, prior to the moving, data tables to accommodate the data messages in the first data storage format and data tables to accommodate the data messages in the second data storage format.

7. A system according to claim 1, further comprising:
monitoring the moving, transforming, and archiving for an error in each of these respective operations; and
transmitting a error alert message in the event an error is detected to the archiving operation.

8. A computer-implemented method comprising:
writing a stream of data messages to a first data structure of a first data storage format, the data messages each being written to the first data structure based on a topic and partition associated with each respective data message;
committing the writing of the data messages to first data structure as a transaction;
moving the data messages in the first data structure to a staging area for a data structure of a second data storage format, the data structure of a second data storage format being different than the data structure of the first data storage format;
transforming the data messages to the second data storage format; and
archiving the data messages in the first data structure after a completion of the transforming of the data messages.

9. A method according to claim 8, wherein the committing of the writing of the data messages to first data structure as a transaction includes acknowledging the commitment after the writing data messages to the first data structure is completed.

10. A method according to claim 8, wherein the writing and committing the writing of the data messages to first data structure as a transaction comprises:
writing a partition queue in-memory buffer to the first data storage format as a write-ahead log;
marking the write-ahead log as being in a committed state;
acknowledging an offset range of the write-ahead log; and
closing the write-ahead log of the partition queue.

11. A method according to claim 8, further comprising:
merging a plurality of the data messages until a size of a record of the merged data messages is a threshold size, wherein the committing of the writing of the data messages to first data structure includes writing the record of the merged data messages to the first data structure.

12. A method according to claim 8, wherein the second data storage format is optimized for querying.

13. A method according to claim 8, further comprising creating, prior to the moving, data tables to accommodate the data messages in the first data storage format and data tables to accommodate the data messages in the second data storage format.

14. A method according to claim 8, further comprising:
monitoring the moving, transforming, and archiving for an error in each of these respective operations; and
transmitting a error alert message in the event an error is detected to the archiving operation.

15. A non-transitory computer readable medium having executable instructions stored therein, the medium comprising:
instructions to write a stream of data messages to a first data structure of a first data storage format, the data messages each being written to the first data structure based on a topic and partition associated with each respective data message;
instructions to commit the writing of the data messages to first data structure as a transaction;
instructions to move the data messages in the first data structure to a staging area for a data structure of a second data storage format, the data structure of a second data storage format being different than the data structure of the first data storage format;
instructions to transform the data messages to the second data storage format; and
instructions to archive the data messages in the first data structure after a completion of the transforming of the data messages.

16. A medium according to claim 15, wherein the committing of the writing of the data messages to first data structure as a transaction includes acknowledging the commitment after the writing data messages to the first data structure is completed.

17. A medium according to claim 15, wherein the writing and committing the writing of the data messages to first data structure as a transaction comprises:
instructions to write a partition queue in-memory buffer to the first data storage format as a write-ahead log;
instructions to mark the write-ahead log as being in a committed state;
instructions to acknowledge an offset range of the write-ahead log; and
instructions to close the write-ahead log of the partition queue.

18. A medium according to claim 15, further comprising:
instructions to merge a plurality of the data messages until a size of a record of the merged data messages is a threshold size, wherein the committing of the writing of the data messages to first data structure includes writing the record of the merged data messages to the first data structure.

19. A medium according to claim 15, wherein the second data storage format is optimized for querying.

20. A medium according to claim 15, further comprising creating, prior to the moving, data tables to accommodate the data messages in the first data storage format and data tables to accommodate the data messages in the second data storage format.
